(19) United States
(12) Patent Application Publication
(10) Pub. No.: US 2004/0145101 A1
(43) Pub. Date: Jul. 29, 2004

(54) Coil and air suspension system

(76) Inventor: Steven J. Olds, Colorado Springs, CO (US)

Correspondence Address: Lisa Wunderlich, Sram Corporation, 4th Floor, 1333 North Kingsbury Street, Chicago, IL, 60622, US

(21) Appl. No.: 10/473,326

(22) PCT Filed: Mar. 29, 2002
(86) PCT No.: PCT/US02/09904

(51) Int. Cl. F16F 9/43; F16F 9/00

(52) U.S. Cl. 267/64.28; 267/71

(57) ABSTRACT

The present invention includes a suspension apparatus with telescoping tubular elements, and a mechanical spring in parallel with an air spring chamber, positioned in one of the tubular elements, providing a mechanism for adjustment of the air spring pressure, the weight of the apparatus, and resistance of the apparatus to compressive shocks.

### BACKGROUND OF THE INVENTION

1. Field

The present invention relates to the field of vehicle suspension systems; more particularly, the invention disclosed herein relates to the field of suspension systems for bicycles.

2. State of the Art

Suspension systems have been used for various applications, such as cushioning impacts, vibrations, or other disturbances experienced by vehicles and machinery. A common application of a suspension system is in bicycles and motorcycles for cushioning impacts or vibrations experienced by the rider when the bicycle or motorcycle is ridden over bumps, ruts, rocks, pot holes, or other obstacles in the rider's path. Suspension systems may be provided along any desired part of the bicycle or motorcycle frame that would benefit from the effects of a suspension system. Typically, a suspension system is provided in the form of two slidable tubular elements with a spring element or system provided therein. The spring system places the tubular elements into a spaced apart condition when the suspension system is under neutral (i.e., no external load) conditions. Various types of spring systems may be used, including coil springs, elastomer assemblies, air springs, and hydraulic systems. The tubular elements are positioned to slidably move with respect to each other upon impact to the frame, with the spring system therein resisting the compression forces.

Bicycles incorporating suspension systems have become increasingly common. One popular form of bicycle suspension system is a suspension fork having a pair of upper tubular fork elements slidable with respect to a pair of lower tubular fork elements, both pairs straddling the front wheel of the bicycle. Because the fork elements are preferably telescopically slidable with respect to each other, two of the elements may be considered inner fork elements and the other two elements are then considered outer fork elements within which the inner fork elements slide. Typically, the upper pair of tubular elements are the inner fork elements and lower pair are the outer fork elements. However, the reverse arrangement may also be used.

In order to enhance the performance of suspension systems further, damping systems have been provided to dampen the motion of the suspension system. Such damping systems may be formed within the tubular elements of the suspension system as in U.S. Pat. Nos. 5,445,401 to Bradbury and 4,561,669 to Simons. More preferably, the damping system may be provided in a self-contained damping cartridge. As described in U.S. Pat. No. 5,456,480 to Turner et al., such damping cartridges provide a number of benefits. For example, damping cartridges typically reduce overall weight (because less damping fluid or gas is needed), permit interchangeability and replacement of damping cartridges, and generally reduce the amount of leakage that may occur. Damping systems may be used in combination with shock absorbing springs, which resist the compressive forces. In some systems, the primary elements of the damping structure may be in one leg of a suspension fork, and the primary elements of the spring structure may be in the other leg of the suspension fork.

The degree of suspension, or extent to which the slidable legs “travel” when subject to an external load, is dependent on a number of factors, including the path or terrain over which the bicycle or motorcycle is ridden, the characteristics of the damping and spring apparatus being used, the bicycle/motorcycle speed, rider weight, and other factors. It is well known that during certain uses, and/or given certain situations, damping and spring characteristics of the fork which are suitable and desirable for one terrain or set of riding conditions are not suitable or desirable for other terrains or conditions. Therefore, adjustability of the damping and/or spring characteristics of the bicycle or motorcycle suspension fork is important for the proper functioning of suspension systems.

### SUMMARY OF THE INVENTION

The present application relates to an adjustable suspension system in which an air spring and mechanical spring operate in parallel, within the same enclosed system, to resist compressive shocks, and in which the spring stiffness of the system can be adjusted over a continuous range by adding to or reducing the air pressure of the air spring.

An object of the present invention is to address the need for an adjustment device that easily tunes the suspension system to rider weight and other external loads on the suspension system. A further object of the invention is to address the need for reduction in the weight of the fork while also preserving the reliability, efficiency and other advantages of a coil or other mechanical spring for resisting compressive forces. A further object, in one embodiment of the invention, is to provide the advantage of an air spring but to provide a low pressure air spring system which is less prone to failure, and which, in the event of failure, is backed up by a mechanical spring system operating in parallel.

These and other objects of the present invention are accomplished by providing a suspension system for wheeled vehicles such as bicycles or motorcycles. In a preferred embodiment, the suspension system has two telescoping legs, one leg providing the primary elements of a damping structure, and the other leg providing the primary elements of a spring structure. The leg providing the spring structure includes an inner tube element and an outer tube element. The inner tube element is inserted into and is slidable in a telescoping fashion within the outer tube element. The inner tube element and outer tube element are biased apart by a mechanical spring which preferably is a coil spring positioned in the upper portion of the inner tube element. Other types of springs and spring assemblies may be used, including elastomeric springs, and multiple coil springs and elastomers. In a preferred aspect of the invention, the coil spring provides a resistant force against a piston which moves longitudinally within the inner tube element. The spring is preferably seated at one end against the top end of the inner tube element and at the other end on the upper surface of the piston. One or more spring perches or other similar means may be used for aligning the spring and supporting it within the inner tube element, and against the piston and top end of the inner tube element. The piston is attached on its lower surface to a piston rod, which extends through the bottom portion of the inner tube element and exits the inner tube element. At its bottom end, the piston rod is attached to the outer tube element. The piston has a sealing means which creates an air tight seal with the inner wall surfaces of the inner tube element. The inner tube element is closed at its top end, creating an air tight seal. The piston, the top end of the inner tube element, and the portion of the inner side walls of the inner tube element between the piston and the top end of the inner tube element form a chamber that acts as an air spring.

The air spring chamber may be pressurized by the introduction of additional air, to raise the air pressure within the chamber above atmospheric pressure. Preferably, the pressure within the chamber is maintained above atmospheric pressure, but at a low pressure, so that the sealing means of the piston and the walls and top end of the inner tube element are not stressed and subject to fissures and leaks. Preferably, a valve means is provided in the top portion of the inner tube element, so that air may be introduced into and released from the chamber according to rider preference, to stiffen or relax the air spring as a function of rider weight, or other external loads on the bicycle or motorcycle, or in accordance with terrain or other riding conditions. In one embodiment, the top portion of the inner tube element is closed with a top cap, which connects releasably and sealingly with the top portion of the inner tube element. The top cap includes the valve means, such as a Shrader valve. The top cap may be sized so that it can be removed to allow withdrawal and replacement of the coil spring to suit the rider's preference as to the stiffness of the coil spring.

The coil spring and air spring are both contained within the inner tube element, and further are confined within the sealed chamber formed by the piston, the top end of the inner tube element, and the inner side walls of the inner tube element. The coil spring and the air spring are positioned within the inner tube element so that they act in parallel in response to compressive forces acting against the piston. It is also possible to position the coil spring and air spring in a cartridge assembly, that fits within the inner tube element. When the outer tube element and piston are forced upwards in response to a compressive force, the piston moves slidably upward within the inner tube element, causing an upward force against the coil spring and the air spring. The movement of the piston within the inner tube element reduces the volume of the chamber, increasing the internal air pressure of the chamber. Because, in a preferred embodiment, the air spring is maintained at a low pressure (slightly above atmospheric pressure), the resistive force of the air spring is comparatively small when the fork experiences minor bumps on the road or trail. With smaller bumps, the coil spring in this embodiment provides the primary response. With larger bumps, as the chamber is substantially compressed by the piston moving upwards towards the top end of the inner tube element, the air spring becomes more of a factor, and contributes a comparatively greater share of the overall resistance to compressive forces than with smaller bumps.

The use of the air spring in parallel with the coil spring permits the use of lighter coil springs which reduce the overall weight of the suspension fork. In addition, because, in a preferred embodiment, the pressure of the air spring is adjusted via a valving means in the inner tube element, by introducing or releasing air to and from the chamber, the pressure of the air spring may be coordinated with the weight of the coil spring. The size or weight of the coil spring may be adjusted as a function of rider weight and preferences and riding conditions. The coil spring may be removed from the top end (such as by opening the top cap and pulling the coil spring out) of the inner tube element and replaced with a coil spring having a different spring rate. Also, the spring preload of the coil spring may be adjusted in any of several ways known in the art, including an external adjustment through a structure included in the top cap. Additionally, the amount of pressure in the air spring may be adjusted as a function of the rider weight, riding conditions, etc. The adjustment of the pressure of the air spring can be done easily, with a tire pump, on the trail, providing fine tuning of the suspension and shock absorbing characteristics of the fork. In one embodiment of the invention, the use of a low pressure air spring places less stress on the sealing means of the piston and the other sealing connections that may be present in the upper end of the inner tube element. The use of an air spring in parallel with a coil spring provides the additional advantage that, if the air spring fails and loses pressure, the coil spring provides a back-up shock absorbing function such that the fork does not fail completely.

While the invention is described in terms of only one leg of a front suspension fork, it can be incorporated into both legs of a front fork, or into a rear suspension system, or into a front single column shock absorber, or into suspension systems used at other locations on a vehicle. In addition, while the air spring preferably uses air, another gas could be used, such as nitrogen, and the system could be a fully contained and sealed system, which does not permit the introduction or release of air or gas through a valving means.

### BRIEF DESCRIPTION OF THE DRAWINGS

FIG. 1 depicts an embodiment of the suspension system of the present invention.

FIG. 2 depicts another aspect of the embodiment of the present invention.

### DETAILED DESCRIPTION

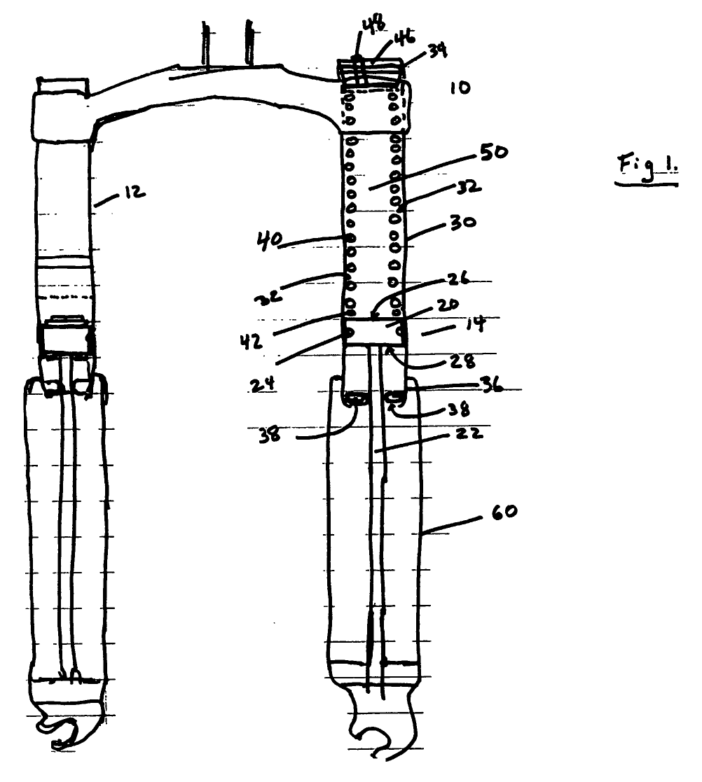

The present invention will now be illustrated with reference to the embodiment of the invention depicted in FIG. 1. In FIG. 1, the suspension system is constructed of a front suspension fork 10 having a first leg 12 containing the primary damping structure and a second leg 14 containing the primary spring structure. The leg 14 contains a piston 20 and a piston rod 22, the piston 20 having sealing means 24. The piston 20 is located within an inner tube element 30. The piston 20 moves longitudinally within the inner tube element 30, the sealing means 24 creating an airtight seal between the sides of the piston 20 and the inner side walls 32 of the inner tube element 30, but permitting the piston 20 to move slideably along the inner side walls 32 of the inner tube element 30. The sealing means 24 is an o-ring or other similar element for creating an air tight seal between the sides of the piston 20 and the inner side walls 32 of the inner tube element 30. The inner tube element 30 has a top end 34 and a bottom end 36. The piston rod 22 extends outward from the inner tube element 30 through its bottom end 36, connecting to the outer tube element 60. As depicted in FIG. 1, a gland structure 38 is positioned in the bottom end 36 of the inner tube element 30, and serves to close the bottom end 36 of the inner tube element 30. The gland structure 38 serves to prevent dust and other contaminants from entering the bottom end 36 of the inner tube element 30.

The piston 20 includes an upper surface 26 and a lower surface 28. A coil spring 40 is positioned within the inner tube element 30. The coil spring 40 has a bottom end 42 that is seated on the upper surface 26 of the piston 20. The coil spring 40 also has a top end 44, that is seated against the top end 34 of the inner tube element 30. The top end 34 is closed with an air tight seal. In a preferred embodiment depicted in FIG. 1, the top end 34 is closed with a top cap 46, which closes and seals the top end 34 of the inner tube element 30. The upper surface 26 of the piston 20, the inner side walls 32, and the bottom surface of the top cap 46 form an air spring chamber 50, which is pressurized with air to form an air spring. As depicted in FIG. 1, the top cap 46 has a valve means 48, such as a Shrader valve, for introducing air into the air spring chamber 50, and releasing air from the chamber 50. The valve means 48 may also be positioned in another location, such as in the side walls of the inner tube element 30. The valve means 48 serves as an adjustment mechanism by which the pressure within the air spring chamber 50 may be increased or decreased to accommodate varying rider weights or riding conditions. In addition, the pressure of air within the air spring chamber 50 may be increased if it is desired to replace a coil spring of one weight with a coil spring having a lighter weight and/or lower spring rate. For example, a softer coil spring may be used with heavier riders by increasing the air pressure in the air spring chamber 50. In another aspect of the invention, the coil spring rate can be adjusted by a spring preload device. This spring preload device may be included in the top cap 46, or included in the inner tube element by another method known in the art.

In the present invention, the coil spring 40 and the air spring of the air spring chamber 50 respond to compressive forces experienced by the fork in parallel. A gas other than air, such as nitrogen, may be used in the air spring chamber 50. Other types of mechanical springs, such as elastomers, and spring structures, including structures comprised of two or more coil springs, or two or more elastomers, or combinations of coil springs, elastomers and/or spacer assemblies, may be used. Further, the chamber 50 and the coil spring 40 may be contained within a cartridge type structure.

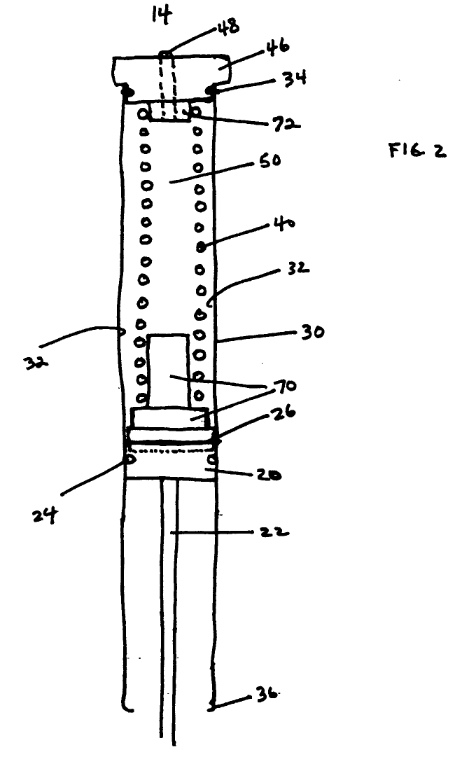

As depicted in FIG. 2, another aspect of the invention includes a spring perch 70 positioned on the upper surface 26 of the piston 20. The spring perch 70 serves to align and support the spring 40. The invention as depicted in FIG. 2 also includes a further spring perch 72 attached to the bottom of the top cap 46. This also serves to align and support the spring 40. The spring perches 70, 72 are separate elements that connect releasably to the piston 20 and the top cap 46, or, in an alternative embodiment, they are shaped elements of the piston 20 and top cap 46. As depicted in FIG. 2, the spring perch 70 connects loosely to the piston 20 by being seated within a counterbore in the upper surface 26 of the piston 20.

It will be appreciated that there are other structures by which the coil spring and air spring may be positioned within a closed system in parallel in a shock absorbing system. The spirit and scope of any appended claims should not be limited to the description of the preferred versions contained herein.

1. A suspension apparatus, comprising:
an inner tube element, having a side wall, a top end and a bottom end;
an outer tube element, having a side wall, an open top end, and a closed bottom end, the bottom end of said inner tube element being telescopingly inserted into the top end of said outer tube element;
a piston slidingly engaged with the inner surface of the side wall of said inner tube element, said piston having an upper surface and a lower surface, and having sealing means forming a seal between said piston and said inner surface of the side walls of said inner tube element to resist the movement of air past such sealing means;
a piston rod, having a first end and a second end, the first end attached to said lower surface of said piston and the second end attached to the bottom end of said outer tube element;
a cap connected to the top end of said inner tube element to effect an air seal;
an air spring chamber within said inner tube element defined by the side wall, said upper surface of said piston and said cap with air in said air spring chamber for resisting movement of said piston on a compressive stroke of said piston;
a mechanical biasing means, having a top end and a bottom end, the bottom end being positioned proximate the upper surface of said piston, and the top end being positioned proximate said cap, said mechanical biasing means being compressible upon movement of said piston toward said cap and configured to resist movement of said piston; and
a valve means, positioned on said inner tube element operable between an open position for introducing air into, and releasing air from, said air spring chamber and a closed position to retain air in said air spring chamber.

2. The apparatus of claim 1, wherein said valve means is a Shrader valve positioned in said top cap.

3. The apparatus of claim 1, wherein said mechanical biasing means is a coil spring.

4. The apparatus of claim 1, wherein said mechanical biasing means is an elastomeric spring.

5. The apparatus of claim 3, further comprising a first spring perch, positioned on the upper surface of said piston and configured to contact one end of said coil spring and a second spring perch attached to said top cap and configured to contact the other end of said coil spring.

6. The apparatus of claim 1, further comprising a spring preload means, connected to said top cap, for adjusting the spring rate of said mechanical biasing means.

7. A method for adjusting the resistance of a suspension apparatus to shock forces, comprising:
providing a suspension system having
an inner tube element, having a side wall, a top end and a bottom end,
an outer tube element, having a side wall, an open top end, and a closed bottom end, the bottom end of said inner tube element being telescopingly inserted into the top end of said outer tube element,
a piston slidingly engaged with the inner surface of the side wall of said inner tube element, said piston having an upper surface and a lower surface, and having sealing means forming a seal between said piston and said inner surface of the side walls of said inner tube element to resist the movement of air past such sealing means,
a piston rod, having a first end and a second end, the first end attached to said lower surface of said piston and the second end attached to the bottom end of said outer tube element,
a cap connected to the top end of said inner tube element to effect an air seal,
an air spring chamber within said inner tube element defined by the side wall, said upper surface of said piston and said cap with air in said air spring chamber for providing a preselected amount of air to resist movement of said piston on a compressive stroke of said piston and provide a first resistance,
a mechanical biasing means, having a top end and a bottom end, the bottom end being positioned proximate the upper surface of said piston, and the top end being positioned proximate said cap, said mechanical biasing means being compressible upon movement of said piston toward said cap and configured to resist movement of said piston, and said mechanical biasing means being selected to provide a second resistance, and
a valve means, positioned on said inner tube element operable between an open position for introducing air into, and releasing air from, said air spring chamber and a closed position to retain air in said air spring chamber;
removing and replacing said first mechanical biasing means with a second mechanical biasing means, said second mechanical biasing means being lighter in weight than said first mechanical biasing means and said second mechanical biasing means having a third resistance which is less than said second resistance; and
connecting a supply of air to said valve means;
introducing air through said valve means into said air spring chamber to change said first resistance to a fourth resistance which is greater than said first resistance and of a value so that the combined resistance of said third resistance and said fourth resistance is essentially the same as the first resistance and the second resistance.

8. The method of claim 7 wherein said first mechanical biasing means and said second mechanical biasing means are coil springs.

9. The method of claim 7 wherein said first mechanical biasing means and said second mechanical biasing means are at least one elastically deformable elastomer section.
